(19) United States
(12) Patent Application Publication
(10) Pub. No.: US 2016/0362969 A1
(43) Pub. Date: Dec. 15, 2016

(54) SIMULTANEOUS INJECTION OF AN ACIDIC WELL TREATMENT FLUID AND A PROPPANT INTO A SUBTERRANEAN FORMATION

(71) Applicant: Calfrac Well Services Ltd., Calgary (CA)

(72) Inventors: Kyle Sinclair-Smith, Okotoks (CA); Rehan Alibhai, Calgary (CA); Youssouf Zotskine, Chestermere (CA)

(73) Assignee: Calfrac Well Services Ltd.

(21) Appl. No.: 14/734,389

(22) Filed: Jun. 9, 2015

(51) Int. Cl. E21B 43/16; C09K 8/74; E21B 43/267; C09K 8/80

(52) U.S. Cl. CPC E21B 43/16; C09K 8/80; C09K 8/74; E21B 43/267; C09K 2208/28

(57) ABSTRACT

A method of simultaneously injecting a proppant and an acidic well treatment fluid into a subterranean formation is described. The method includes pumping the acidic fluid into the formation while simultaneously pumping a slurry of the proppant in a carrier fluid containing one or more friction reducing agents. The acidic fluid stream and the proppant slurry stream mix before entering the formation and are pumped at approximately equal rates. Also described is a system for simultaneously pumping the acidic fluid and the proppant slurry into the formation.

### BACKGROUND

The present application is directed to a method of simultaneously injecting an acidic well treatment fluid and a proppant into a hydrocarbon-producing subterranean formation, and to a system for carrying out the method.

Fracturing fluids are used in the process of hydraulic fracturing to facilitate the recovery of hydrocarbon deposits within a subterranean formation. Fracturing fluid is generally pumped into the formation at high pressure so as to force the opening of cracks or fissures within the formation, allowing hydrocarbons to flow more easily from the formation. Fracturing fluids often contain large amounts of water, although methanol or hydrocarbons such as diesel, or liquified propane or methane can also be used. Often, fracturing fluids contain a suspended granular solid or proppant which remains in the formation once the fracturing fluid has been removed, where the proppant acts to prop open the channels which are formed. Fracturing fluids often also contain additives to control the viscosity and other properties of the fluids so that adequate quantities of proppant can remain suspended while the fluid is being pumped into the formation, but the proppant can be deposited within the cracks and fissures formed downhole and the remaining components can be readily removed from the fractured formation. Such additives can include viscosifying agents to increase viscosity, facilitating the suspension of proppant for transport into the formation, and breakers to reduce viscosity, thereby allowing proppant to be deposited in the fractures and facilitating the recovery of used fracturing fluid. Highly viscous fracturing fluids, however, experience increased friction when the fluids are pumped into a formation.

Alternatively, formations can be fractured using a slickwater fracturing system. Slickwater fracturing systems are used especially for stimulation of highly pressurized deeper formations, and are generally water-based fluids containing friction-reducing agents so that large volumes of fluid can be pumped rapidly through the wellbore and into the formation. Slickwater fracturing fluids therefore often have reduced viscosity compared to other fracturing fluid systems.

Subterranean formations can be treated with an acidic well treatment fluid during the fracturing process to increase the permeability of formations such as dolomites, limestones and other carbonate mineral-containing formations. The acid reacts with the carbonate minerals, dissolving part of the formation, and thereby creating fractures and cracks through which hydrocarbon deposits can be recovered. Commonly used acidic fluids generally contain strong acids such as hydrochloric acid at relatively high concentrations (for example, 15-28% HCl (w/w)), so that effective reaction with the carbonates in the formation can occur with a relatively low volume of acid.

Because reaction of the acid with the carbonates in the formation is rapid, acid fluids are often pumped into the formation at high rates, so that the acid fluid can penetrate further into the formation before the acid is consumed or spent. In addition, many gelling agents and viscosifiers are not compatible with such low pH conditions. Therefore, acidic well treatment fluids often have a low viscosity, especially if they are to be introduced into the formation at a high rate, for example, in conjunction with a slickwater fracturing process.

Production from an acid-treated formation may decline rapidly once a relatively large part of the formation has already been contacted by acid and accessible carbonates have been dissolved, as new channels are no longer being formed as readily, and existing channels may have collapsed or closed under reservoir stresses. It may therefore be desired to introduce a proppant along with an acidic fluid to prevent the newly formed channels from collapsing or closing.

Because of the low viscosity of the acidic fluids, it can be difficult to incorporate large concentrations of proppant so that the proppant can remain suspended to be carried into the formation. Therefore, proppant has been introduced during acid treatment by alternating the injection of portions of acid fluid with injection of portions of a proppant-containing cross-linked fluid which has a higher viscosity so as to keep the proppant suspended. However, such an approach suffers from the disadvantage that, because cross-linked fluids have higher viscosity and experience higher friction when pumped, they must be pumped at a lower rate than the less viscous acid fluid. This reduces the rate at which the preceding acid fluid is pushed through the formation and therefore reduces the degree of penetration of the acid fluid into the formation. Furthermore, cross-linked fluids are often damaging to formations, creating filter cake and other remnants that reduce longer term conductivity of the formation. However, reducing the amount of cross-linked fluid introduced in order to avoid this damage will in turn undesirably reduce the amount of proppant deposited in the formation.

Therefore, there is a need for a method of injecting proppant into a subterranean formation along with an acidic well treatment fluid so that the proppant can be transported readily into the formation.

### SUMMARY

Accordingly, in one aspect, the present invention is directed to a method of simultaneously injecting a proppant and an acidic well treatment fluid into a subterranean formation, the method including blending a proppant with a carrier fluid containing a friction reducing agent to produce a proppant slurry; pumping the proppant slurry into the formation at a slurry flow rate using a slurry pumping system; and pumping the acidic well treatment fluid into the formation at an acid flow rate using an acid pumping system, such that the proppant slurry is pumped into the formation simultaneously with the acidic well treatment fluid to form a combined fluid, and the slurry flow rate is substantially equal to the acid flow rate.

Another aspect of the present invention is directed to a system for simultaneously injecting a proppant and an acidic well treatment fluid into a subterranean formation. The system includes a slurry pumping system for pumping a proppant slurry stream into the formation at a slurry flow rate and an acid pumping system for pumping an acidic well treatment fluid stream into the formation at an acid flow rate, such that the slurry flow rate is substantially equal to the acid flow rate. The proppant slurry stream contains proppant and a carrier fluid containing one or more friction reducing agents. The proppant slurry stream and the acidic well treatment fluid stream are then mixed to form a combined fluid stream for injection into the formation.

Without being bound by theory, it is believed that, advantageously, simultaneous injection of proppant and an acidic well treatment fluid can, in certain embodiments, aid in preventing job failures due to the blockage of formation pores with proppant (also known as a sand-off or screen-out). If proppant carried by viscosified crosslinked fluids or slickwater should build up at a point in the formation so as to cause a blockage in the fluid flow, it can be necessary to use time-consuming recovery procedures or coiled tubing to complete the well. However, if the proppant is injected simultaneously with an acidic well treatment fluid, the acid can react with the carbonates in the formation at a point that becomes blocked with proppant. In many cases, this can act to create a larger flowpath and eventually release the blockage without the need for further intervention, so that the acidic fluid and proppant can continue to flow in the formation.

### BRIEF DESCRIPTION OF THE DRAWINGS

Further features of the present invention will become apparent from the following written description and the accompanying figures, in which:

FIG. 1 is a diagram illustrating an embodiment of a system for carrying out an embodiment of the method according to the present invention.

### DETAILED DESCRIPTION

The present method includes blending a proppant with a carrier fluid to produce a proppant slurry; pumping the proppant slurry into the formation using a slurry pumping system; and pumping the acidic well treatment fluid into the formation using an acid pumping system, such that the proppant slurry stream mixes with the acidic well treatment fluid stream before entry into the formation, and the proppant slurry is pumped into the formation simultaneously with the acidic well treatment fluid as a combined fluid.

As will be appreciated by the person of skill in the art, the specific conditions under which the proppant slurry and acidic well treatment fluid are prepared and pumped will be selected based on the needs of the particular application, including but not limited to the desired amounts of acid and proppant to be deposited in the formation during the treatment. The particular conditions selected to carry out the present method will be influenced by factors including but not limited to the features of the formation to be treated, including the formation pressure, the geological features of the formation, and the properties of the hydrocarbon deposits therein, and the ambient environmental conditions during the treatment, including but not limited to temperature at the surface and in the formation. In light of the teaching herein, the skilled person would be able to select appropriate proppants, carrier fluids and acidic well treatment fluids, as well as flow rates and blending and pumping conditions suitable for a particular application of the present method.

The proppant used can be any suitable proppant known in the art, and can be selected by the skilled person as appropriate for the formation to be treated. Suitable proppants include but are not limited to sand, ceramic beads, resin-coated proppants and the like, and can have an appropriate size as will be appreciated by the person of skill in the art, including but not limited to a mesh size selected from 20/40 mesh, 30/50 mesh and 40/70 mesh. In at least one embodiment the proppant is sand. In at least one embodiment, the proppant, when soaked with 28% HCl, can pass a crush-resistance test at 4000 psi according to standards accepted in the art (for example, standard API RP 19C, Recommended Practice for Measurement of Proppants Used in Hydraulic Fracturing and Gravel-packing Operations, First Edition (ISO 13503-2:2006)).

The proppant is blended with a carrier fluid to produce a slurry. Suitable carrier fluids are known in the art and will advantageously have a relatively low viscosity so as to be able to carry proppant rapidly into the wellbore with minimal friction. In at least one embodiment, the carrier fluid has a viscosity of no more than about 12 cP. In at least one embodiment, the carrier fluid has a viscosity of from about 2 cP to about 12 cP. In at least one embodiment, the carrier fluid is an aqueous fluid or a water-based fluid containing one or more friction reducing agents. Suitable friction reducing agents include but are not limited to polyacrylamide friction reducing agents, such as are well known in the art. In at least one embodiment, the friction reducing agent is a cationic polyacrylamide friction reducing agent. In at least one embodiment, the carrier fluid can optionally contain one or more additives. Suitable additives include but are not limited to antisludge agents, emulsion control agents, corrosion inhibitors and other additives known in the art. As will be understood by the skilled person, the friction reducing agent and other optional additives are best selected to be compatible with the combined fluid formed when the acidic well treatment fluid is mixed with the proppant slurry. In at least one embodiment, the carrier fluid is CWS-600™ fluid (Calfrac Well Services). The skilled person would be readily able to select or prepare other carrier fluids which would be suitable for the formation to be treated and the hydrocarbon deposits therein.

The acidic well treatment fluid can be any suitable acidic well treatment fluid known in the art which is effective to react with the carbonate minerals in the formation. Suitable acidic well treatment fluids include but are not limited to fluids containing one or more of hydrochloric acid (HCl), hydrofluoric acid (HF) or organic acids, including but not limited to formic acid and acetic acid. The acidic well treatment fluid can be aqueous, and can contain organic components, including but not limited to xylene, and/or other additives, including but not limited to antisludge agents, emulsion control agents, friction reducing agents and corrosion inhibitors, such as are well known in the art. In at least one embodiment, the acidic well treatment fluid comprises aqueous HCl. In at least one embodiment, the aqueous HCl has a concentration of from about 14% to about 36% HCl (w/w). In at least one embodiment, the acidic fluid comprises 28% aqueous HCl (w/w), and can optionally further contain one or more organic components or additives.

In at least one embodiment, the carrier fluid is pumped to a blender at a clean flow rate, where it is mixed with the proppant to form the slurry. As will be appreciated by the person of skill in the art, the specific conditions under which the carrier fluid and proppant are mixed and pumped will be selected based on the needs of the particular application. In at least one embodiment, the carrier fluid is pumped to a blender at a clean flow rate of at least about 1.8 m³/min.

In at least one embodiment, the proppant is contained in the slurry at a concentration of at least about 50 kg/m³. In at least one embodiment, the proppant is contained in the slurry at a concentration of no more than about 1500 kg/m³. In at least one embodiment, the proppant is contained in the slurry at a concentration of from about 50 kg/m³ to about 1100 kg/m³. The skilled person will appreciate that the clean flow rate of the carrier fluid and the rate of addition of proppant can each individually be varied during the blending and pumping of the proppant slurry in order to provide a proppant slurry stream containing proppant at an appropriate concentration and being pumped at a slurry flow rate which is substantially equal to the acid flow rate, as described below.

The proppant slurry is pumped to the formation using a slurry pumping system at a slurry flow rate suitable for mixing with the acidic well treatment fluid, as described in further detail below. In at least one embodiment, the slurry flow rate is from about 2.0 m³/min to about 5.0 m³/min. In at least one embodiment, the slurry flow rate is from about 2.5 m³/min to about 4.5 m³/min. In at least one embodiment, the slurry flow rate is about 4.0 m³/min.

Simultaneously with pumping the proppant slurry, the acidic well treatment fluid is transported to the formation using an acid pumping system, so that the proppant slurry stream and acidic well treatment fluid stream mix and form a combined fluid which enters the formation. In at least one embodiment, the acidic well treatment fluid is pumped at an acid flow rate of from about 2.0 m³/min to about 5.0 m³/min. In at least one embodiment, the acidic well treatment fluid is pumped at an acid flow rate of from about 2.5 m³/min to about 4.5 m³/min. In at least one embodiment, the acidic well treatment fluid is pumped at an acid flow rate of about 4.0 m³/min.

The proppant slurry stream and the acidic well treatment fluid stream are pumped separately at substantially equal rates, and can be combined at any convenient point prior to entry into the formation. As non-limiting examples, the streams can be combined at one or more points between the pumps and the wellhead, at the wellhead, or within the wellbore before entry into the formation, as will be understood in the art.

As used herein, the term “substantially equal rates” or “substantially the same rate” is intended to mean that the proppant slurry and acidic well treatment fluid streams are pumped at rates that will provide a concentration of HCl of about 14% to about 19% (w/w) in the combined fluid stream when the acidic well treatment fluid contains a concentration of HCl of about 28% (w/w). Advantageously, as will be understood by the skilled person, when the proppant slurry stream and the acidic well treatment fluid stream are pumped at substantially equal rates before mixing, the amount of acidic well fluid needed to pump a given volume of combined fluid into the formation can be reduced to save costs, while still allowing the combined fluid to contain a concentration of acid effective to react with the carbonate minerals in the formation. Furthermore, the proppant slurry stream can be pumped at a high enough rate that effective amounts of proppant can be placed in the formation without the need for gellants or viscosifiers to aid in suspending very high concentrations of proppant. Additionally, relatively large amounts of proppant can be placed in the formation simultaneously with a given amount of acidic well treatment fluid.

In at least one embodiment, the combined fluid is pumped into the formation at a combined flow rate of at least about 4.0 m³/min. In at least one embodiment, the combined fluid is pumped into the formation at a combined flow rate of at least about 6.0 m³/min. In at least one embodiment, the combined fluid is pumped into the formation at a combined flow rate of at least about 8.0 m³/min. In at least one embodiment, the combined fluid has a proppant concentration of at least about 25 kg/m³ when the combined fluid enters the formation. In at least one embodiment, the combined fluid has a proppant concentration of from about 50 kg/m³ to about 600 kg/m³ when the combined fluid enters the formation.

In at least one embodiment, the combined fluid has an acid concentration of at least about 14% HCl (w/w) when the combined fluid enters the formation. In at least one embodiment, the combined fluid has an acid concentration of from about 14% HCl to about 19% HCl (w/w) when the combined fluid enters the formation. In at least one embodiment, the acid quality of the combined fluid is at least about 50% when the combined fluid enters the formation. In at least one embodiment, the acid quality of the combined fluid is from about 48% to about 67% when the combined fluid enters the formation. The term “acid quality” as used herein is intended to indicate the relative concentration of the acid in the combined fluid relative to the concentration of the acid in the acidic well treatment fluid, and is calculated by dividing the concentration of the acid in the combined fluid by the concentration of the acid in the acidic well treatment fluid and multiplying the result of the division by 100%.

It will be clear to the person of skill in the art that the specific concentrations or amounts of acid and proppant injected into the well can be controlled by varying at least the flow rates and compositions of the acidic well treatment fluid and the proppant slurry. For example, the proppant concentration and/or the acid quality in the combined fluid can be changed by changing the proppant concentration in the proppant slurry and/or by changing one or both of the proppant slurry flow rate and the acid flow rate.

Furthermore, it may be desired to change the composition of the combined fluid entering the formation over time as the well treatment progresses. For example, it may be desired to increase the proppant concentration and/or the acid quality in the combined fluid over time, such that increasing quantities of proppant are placed in the formation as the acid fluid reacts with the carbonate minerals. In at least one embodiment of such a case, the rate of addition of proppant to the proppant slurry can be increased over time, for example, such that the proppant concentration in the proppant slurry, and thus in the combined fluid, increases over the course of the well treatment. In this way, increasing amounts of proppant will be placed as the treatment progresses. Thus, the present method can be adapted to the particular needs of a specific application, as will be apparent to one skilled in the art.

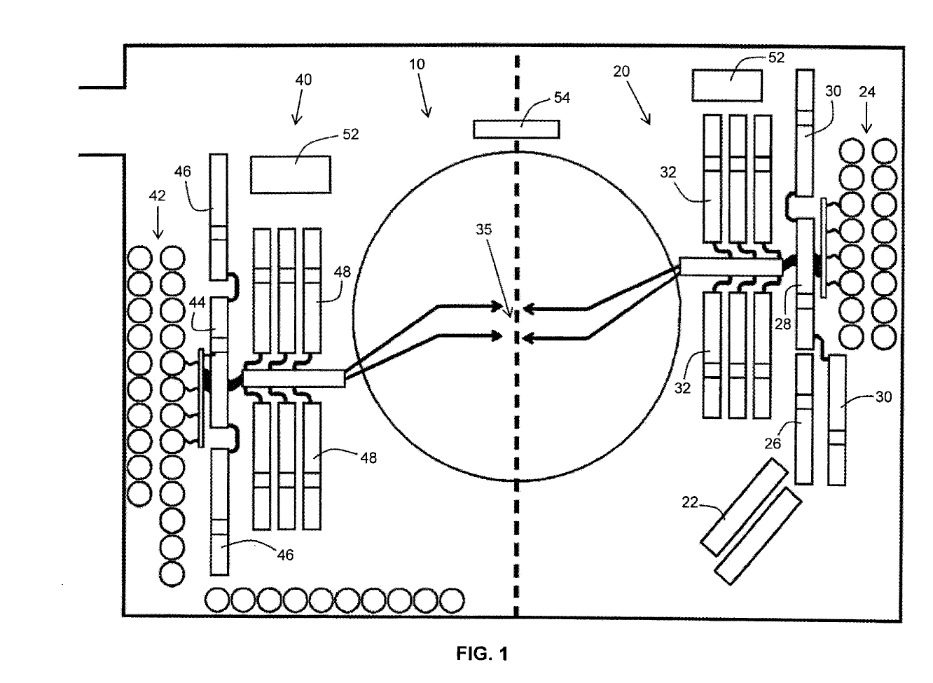

An embodiment of a system for carrying out the method described herein is shown diagrammatically in FIG. 1. System 10 includes slurry pumping system 20, including proppant source 22 and carrier fluid source 24. Sand from proppant source 22 is carried by sand belt 26 to blender 28 where it is blended with carrier fluid from fluid source 24. One or more friction reducing agents and optionally one or more additives are added to blender 28 from additive sources 30. The resulting proppant slurry is pumped to wellhead 35 by one or more pumps 32. System 10 also includes acid pumping system 40, including acidic well treatment fluid source 42 which provides acidic well treatment fluid to blender 44, where the acidic well treatment fluid can be mixed with one or more additives from additive sources 46. One or more pumps 48 then pump the acidic well treatment fluid to the wellhead 35. The streams of proppant slurry and acidic well treatment fluid are combined to form the combined fluid before entering the formation.

As will be understood by the skilled person, system 10 can also include other systems and/or equipment, including but not limited to one or more vacuum sources 52 and control system 54. Furthermore, it will be understood by those skilled in the art that a particular system or piece of equipment can be used in both the slurry pumping system and the acid pumping system, as long as the proppant slurry stream and the acidic well treatment fluid stream are prepared and pumped separately and in isolation from each other until they are combined to form the combined fluid. For example, in at least one embodiment of the present method, use is contemplated of a blender unit which is capable of individually blending components to simultaneously form two individual streams of blended fluid (for example, the present proppant slurry stream and acidic well treatment fluid stream) while preventing those individual streams from mixing with each other, and of discharging each of the separate and isolated blended streams individually to a different pump or group of pumps, for separate and isolated pumping of the individual streams.

### EXAMPLES

Other features of the present invention will become apparent from the following non-limiting examples which illustrate, by way of example, the principles of the invention.

### Example 1

Carrier fluid (CWS600™) is pumped into a blender and blended with sand. The resulting slurry stream is combined with a separately pumped stream of 28% HCl and the combined fluid stream is pumped into a wellhead in stages. Specific representative conditions for treatment of an individual zone of a formation in a ball-actuated, packer-isolated completion method are provided in Tables 1 and 2.

TABLE 1

| | Pumping rate | | | | | | Slurry | Acid | Acid | Proppant |
|---|---|---|---|---|---|---|---|---|---|---|
| | (m³/min) | | | Amount added per stage | | | conc. at | Quality at | conc. at | conc. at |
| | | | 28% | Sand | Carrier | 28% HCl | blender | wellhead | wellhead | wellhead |
| Stage | Carrier | Slurry | HCl | (kg) | (m³) | (m³) | (kg/m³) | (%) | (%) | (kg/m³) |
| 1 | 4.81 | 5.0 | 5.0 | 683 | 6.7 | 7 | 102 | 50.9 | 14.3 | 50 |
| 2 | 4.64 | 5.0 | 5.0 | 1352 | 6.5 | 7 | 208 | 51.9 | 14.5 | 100 |
| 3 | 4.46 | 5.0 | 5.0 | 1972 | 6.2 | 7 | 318 | 52.8 | 14.8 | 150 |
| 4 | 4.30 | 5.0 | 5.0 | 2988 | 6.9 | 8 | 433 | 53.8 | 15.1 | 200 |
| 5 | 4.14 | 5.0 | 5.0 | 3643 | 6.6 | 8 | 552 | 54.7 | 15.3 | 250 |
| 6 | 3.98 | 5.0 | 5.0 | 4333 | 6.4 | 8 | 677 | 55.7 | 15.6 | 300 |

TABLE 2

| | Pumping rate) | | | | | | Slurry | Acid | Acid | Proppant |
|---|---|---|---|---|---|---|---|---|---|---|
| | (m³/min | | | Amount added per stage | | | conc. at | Quality at | conc. at | conc. at |
| | | | 28% | Sand | Carrier | 28% HCl | blender | wellhead | wellhead | wellhead |
| Stage | Carrier | Slurry | HCl | (kg) | (m³) | (m³) | (kg/m³) | (%) | (%) | (kg/m³) |
| 1 | 3.71 | 4.0 | 4.0 | 1349 | 6.5 | 7 | 208 | 51.9 | 14.5 | 100 |
| 2 | 3.44 | 4.0 | 4.0 | 2604 | 6.0 | 7 | 433 | 53.8 | 15.1 | 200 |
| 3 | 3.19 | 4.0 | 4.0 | 3773 | 5.6 | 7 | 677 | 55.7 | 15.6 | 300 |
| 4 | 2.95 | 4.0 | 4.0 | 5561 | 5.9 | 8 | 942 | 57.5 | 16.1 | 400 |
| 5 | 2.73 | 4.0 | 4.0 | 6730 | 5.5 | 8 | 1233 | 59.4 | 16.6 | 500 |
| 6 | 2.52 | 4.0 | 4.0 | 7828 | 5.0 | 8 | 1551 | 61.3 | 17.2 | 600 |

The embodiments described herein are intended to be illustrative of the present compositions and methods and are not intended to limit the scope of the present invention. Various modifications and changes consistent with the description as a whole and which are readily apparent to the person of skill in the art are intended to be included. The appended claims should not be limited by the specific embodiments set forth in the examples, but should be given the broadest interpretation consistent with the description as a whole.

1. A method of simultaneously injecting a proppant and an acidic well treatment fluid into a subterranean formation, the method comprising:
blending the proppant with a carrier fluid to produce a proppant slurry having a proppant concentration, wherein the carrier fluid comprises one or more friction reducing agents and wherein the proppant is resistant to crushing when soaked with acid;
pumping the proppant slurry into the formation as a proppant slurry stream at a slurry flow rate using a slurry pumping system; and
pumping the acidic well treatment fluid into the formation as an acidic well treatment fluid stream at an acid flow rate using an acid pumping system, the proppant slurry and the acid well treatment fluid being prepared separately and in isolation from each other until such time that that the proppant slurry stream and the acid well treatment fluid stream are simultaneously pumped into the formation;
mixing the proppant slurry stream with the acidic well treatment fluid stream to form a combined fluid stream, wherein the step of mixing occurs only after the step of pumping the proppant slurry stream and pumping the acidic well treatment fluid stream;
wherein the slurry flow rate is substantially equal to the acid flow rate.

2. The method according to claim 1 wherein the carrier fluid comprises a cationic polyacrylamide friction reducing agent.

3. The method according to claim 1 wherein the carrier fluid has a viscosity of no more than about 12 cP.

4. The method according to claim 1 wherein the acidic well treatment fluid comprises aqueous HCl at a concentration of from about 14% to about 36% by weight.

5. The method according to claim 4 wherein the acidic well treatment fluid comprises aqueous HCl at a concentration of about 28% by weight.

6. The method according to claim 1 wherein the proppant concentration is from about 50 kg/m³ to about 1500 kg/m³.

7. The method according to claim 1 wherein the slurry flow rate is from about 2.0 m³/min to about 5.0 m³/min and wherein the acid flow rate is from about 2.0 m³/min to about 5.0 m³/min.

8. The method according to claim 1 wherein one or more of the proppant concentration, the slurry flow rate and the acid flow rate are varied as the proppant slurry stream and the acidic well treatment fluid stream are pumped simultaneously into the formation.

9. A system for simultaneously injecting a proppant and an acidic well treatment fluid into a subterranean formation, the system comprising:
a slurry pumping system for pumping a proppant slurry stream at a slurry flow rate, wherein the proppant slurry stream comprises a carrier fluid and the proppant, wherein the proppant slurry stream has a proppant concentration, wherein the proppant is resistant to crushing when soaked with acid and wherein the carrier fluid comprises one or more friction reducing agents; and
an acid pumping system for pumping an acidic well treatment fluid stream separate from the proppant slurry stream at an acid flow rate;
wherein the proppant slurry and the acid well treatment fluid are prepared and pumped separately and in isolation from each other until such time that the proppant slurry stream and the acid well treatment fluid stream are pumped into the formation simultaneously and the proppant slurry stream is mixed with the acidic well treatment fluid stream to form a combined fluid stream for injection into the formation, and
wherein the slurry flow rate is substantially equal to the acid flow rate.

10. The system according to claim 9 wherein the carrier fluid comprises a cationic polyacrylamide friction reducing agent.

11. The system according to claim 9 wherein the carrier fluid has a viscosity of no more than about 12 cP.

12. The system according to claim 9 wherein the acidic well treatment fluid comprises aqueous HCl at a concentration of from about 14% to about 36% by weight.

13. The system according to claim 12 wherein the acidic well treatment fluid comprises aqueous HCl at a concentration of about 28% by weight.

14. The system according to claim 9 wherein the proppant concentration is from about 50 kg/m³ to about 1500 kg/m³.

15. The system according to claim 9 wherein the slurry flow rate is from about 2.0 m³/min to about 5.0 m³/min and wherein the acid flow rate is from about 2.0 m³/min to about 5.0 m³/min.

16. The system according to claim 9 wherein the system is configured to vary one or more of the concentration of proppant, the slurry flow rate and the acid flow rate as the proppant slurry stream is mixed with the acidic well treatment fluid stream to form the combined fluid stream.
